(19) United States
(12) Patent Application Publication
(10) Pub. No.: US 2016/0207173 A1
(43) Pub. Date: Jul. 21, 2016

(54) CLAMPING DEVICE FOR INSCRIBING MACHINE

(71) Applicant: CITIC Dicastal CO., LTD, Qinhuangdao (CN)

(72) Inventors: Weidong LIU, Qinhuangdao (CN); Wenjin SHI, Qinhuangdao (CN); Fengyan LIU, Qinhuangdao (CN); Jiandong GUO, Qinhuangdao (CN); Xiaoguang HUANG, Qinhuangdao (CN); Bowen XUE, Qinhuangdao (CN); Yongning WANG, Qinhuangdao (CN); Zhihua ZHU, Qinhuangdao (CN); Changhai LI, Qinhuangdao (CN)

(73) Assignee: CITIC Dicastal CO., LTD, Qinhuangdao (CN)

(21) Appl. No.: 14/994,621

(22) Filed: Jan. 13, 2016

(30) Foreign Application Priority Data
Jan. 20, 2015 (CN) 201510027904.8

(51) Int. Cl. B25B 1/18; B25B 1/20

(52) U.S. Cl. CPC B25B 1/18; B25B 1/20

(57) ABSTRACT

The present invention relates to a universal clamping device for an inscribing machine, having a frame, a base plate, a cushion plate, a fixed support, a lead screw, a linear guide rail, a guide rail slide carriage, a lead screw nut, a bracket, a mandrel, a protective cap, a driven pulley, a fixed support, a synchronous belt, a driving pulley, a mounting rack and a servo motor. The device provided by the present invention can meet the requirements on inscribing work, and is also featured by being simple in structure, convenient to manufacture and stable in performance.

### TECHNICAL FIELD

The present invention relates to a clamping device, and more particularly to a clamping device for an inscribing machine used in the process of wheel machining.

### BACKGROUND ART

Wheel type-related information needs to be inscribed on the outer rim of a wheel in the industry of automobile wheel production. Since different wheel types are different in dimension and structure, one kind of wheel type requires a set of dedicated inscribing machine clamp, which will increase the production cost of wheel manufacturers to some extent and bring disadvantages to long-term development of these manufacturers. Provided in the present invention is a universal clamp for an inscribing machine.

### SUMMARY OF THE INVENTION

An object of the present invention is to provide a universal clamping device for an inscribing machine.

To achieve the above-mentioned object, the technical solution of the present invention is as follows: A universal clamping device for an inscribing machine consists mainly of a frame, a base plate, a cushion plate, a fixed support, a lead screw, a linear guide rail, a guide rail slide carriage, a lead screw nut, a bracket, a mandrel, a protective cap, a driven pulley, another fixed support, a synchronous belt, a driving pulley, a mounting rack and a servo motor, and is characterized in that: the mounting rack and the base plate are fixed on the frame, the linear guide rail is connected with the base plate through the cushion plate, the bracket is connected with the linear guide rail through the guide rail slide carriage, the mandrel and the protective cap are fixed on the bracket, the lead screw is mounted on the two fixed supports, the bracket is connected with the lead screw through the lead screw nut, the driven pulley is fixed on one end of the lead screw, the servo motor is fixed on the mounting rack, the output end of the servo motor is connected with the driving pulley, and the driven pulley and the driving pulley are connected with each other through the synchronous belt. The servo motor starts operating, and the bracket can be moved horizontally along the linear guide rail through pulley drive and lead screw drive.

During actual use, a wheel is placed on the bracket with its front side facing downwards, and the cap opening of the wheel is brought into full contact with the mandrel. Afterwards, the servo motor starts operating, the lead screw starts rotating through the driven pulley, the driving pulley and the synchronous belt, and the bracket drives the wheel to move horizontally along the linear guide rail through lead screw drive between the lead screw and the lead screw nut. On the basis of the dimensional and structural characteristics of different wheels, the servo motor is capable of controlling the wheel to move to a designated location on the inscribing machine, and then the inscribing machine starts inscribing on the wheel.

The present invention can meet the requirements on inscribing work, and is also featured by being simple in structure, convenient to manufacture and stable in performance.

### BRIEF DESCRIPTION OF THE DRAWINGS

FIG. 1 is a schematic view illustrating the structure of a universal clamping device for an inscribing machine of the present invention.

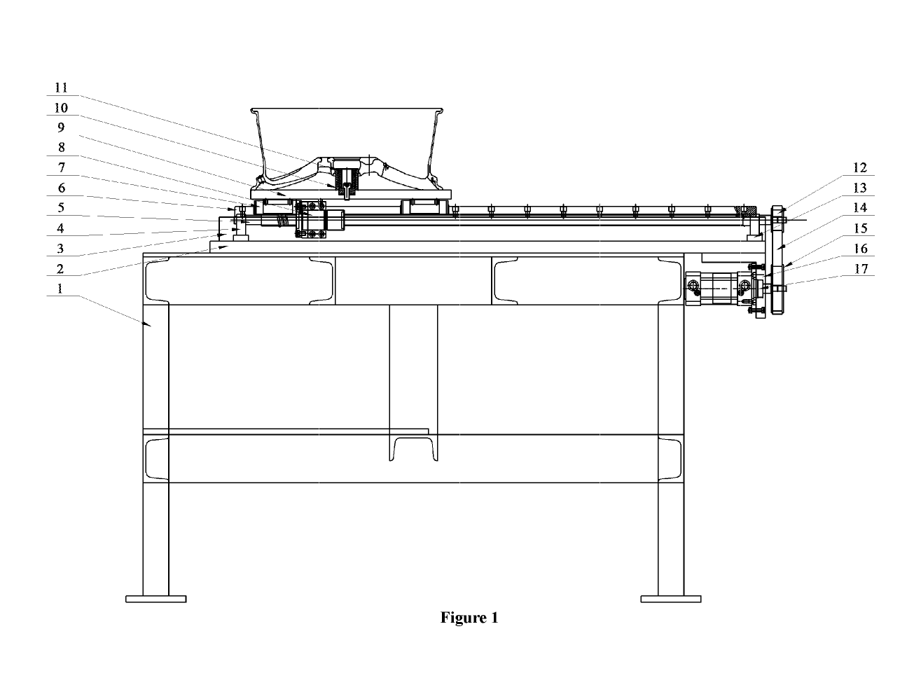

FIG. 2 is a top view of a universal clamping device for an inscribing machine of the present invention.

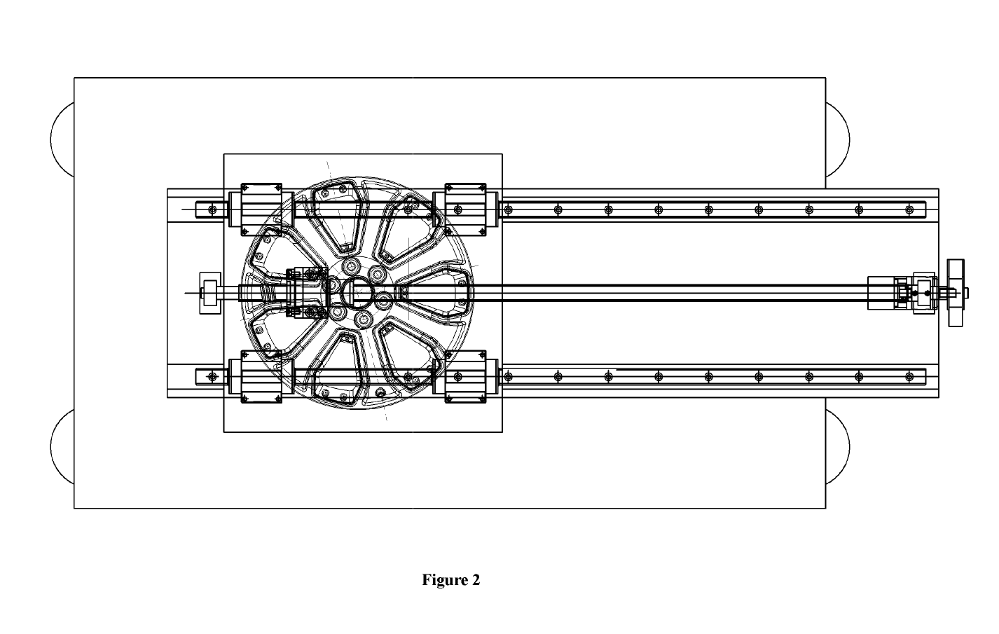

In the drawings, 1-frame, 2-base plate, 3-cushion plate, 4-fixed support A, 5-lead screw, 6-linear guide rail, 7-guide rail slide carriage, 8-lead screw nut, 9-bracket, 10-mandrel, 11-protective cap, 12-driven pulley, 13-fixed support B, 14-synchronous belt, 15-driving pulley, 16-mounting rack, 17-servo motor.

### DETAILED DESCRIPTION

The details and operating condition of the specific device set forth in accordance with the present invention will be described below in details in conjunction with the accompanying drawings. A universal clamping device for an inscribing machine consists mainly of a frame 1, a base plate 2, a cushion plate 3, a fixed support A 4, a lead screw 5, a linear guide rail 6, a guide rail slide carriage 7, a lead screw nut 8, a bracket 9, a mandrel 10, a protective cap 11, a driven pulley 12, a fixed support B 13, a synchronous belt 14, a driving pulley 15, a mounting rack 16 and a servo motor 17, and is characterized in that: the mounting rack 16 and the base plate 2 are fixed on the frame 1, the linear guide rail 6 is connected with the base plate 2 through the cushion plate 3, the bracket 9 is connected with the linear guide rail 6 through the guide rail slide carriage 7, the mandrel 10 and the protective cap 11 are fixed on the bracket 9, the lead screw 5 is mounted on the fixed support A 4 and the fixed support B 13, the bracket 9 is connected with the lead screw 5 through the lead screw nut 8, the driven pulley 12 is fixed on one end of the lead screw 5, the servo motor 17 is fixed on the mounting rack 16, the output end of the servo motor 17 is connected with the driving pulley 15, and the driven pulley 12 and the driving pulley 15 are connected with each other through the synchronous belt 14. The servo motor 17 starts operating, and the bracket 9 can be moved horizontally along the linear guide rail 6 through pulley drive and lead screw drive.

During actual use, a wheel is placed on the bracket 9 with its front side facing downwards, and the cap opening of the wheel is brought into full contact with the mandrel 10. Afterwards, the servo motor 17 starts operating, the lead screw 5 starts rotating through the driven pulley 12, the driving pulley 15 and the synchronous belt 14, and the bracket 9 drives the wheel to move horizontally along the linear guide rail 6 through lead screw drive between the lead screw 5 and the lead screw nut 8. On the basis of the dimensional and structural characteristics of different wheels, the servo motor 17 is capable of controlling the wheel to move to a designated location on the inscribing machine, and then the inscribing machine starts inscribing on the wheel.

1. A universal clamping device for an inscribing machine, comprising:
a frame, a base plate, a cushion plate, a fixed support A, a lead screw, a linear guide rail, a guide rail slide carriage, a lead screw nut, a bracket, a mandrel, a protective cap, a driven pulley, a fixed support B, a synchronous belt, a driving pulley, a mounting rack and a servo motor; wherein the mounting rack and the base plate are fixed on the frame, the linear guide rail is connected with the base plate through the cushion plate, the bracket is connected with the linear guide rail through the guide rail slide carriage, the mandrel and the protective cap are fixed on the bracket, the lead screw is mounted on the fixed support A and the fixed support B, the bracket is connected with the lead screw through the lead screw nut, the driven pulley is fixed on one end of the lead screw, the servo motor is fixed on the mounting rack, the output end of the servo motor is connected with the driving pulley, and the driven pulley and the driving pulley are connected with each other through the synchronous belt; and further wherein the servo motor starts operating, and the bracket can be moved horizontally along the linear guide rail through pulley drive and lead screw drive.
